(19) United States
(12) Patent Application Publication
(10) Pub. No.: US 2008/0267650 A1
(43) Pub. Date: Oct. 30, 2008

(54) IMAGE FORMING APPARATUS

(75) Inventor: Jong Min KIM, Suwon-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 12/099,258

(22) Filed: Apr. 8, 2008

(30) Foreign Application Priority Data
Apr. 26, 2007 (KR) 2007-40596

(51) Int. Cl. G03G 15/20

(52) U.S. Cl. 399/68

(57) ABSTRACT

An image forming apparatus includes a heat roller having a heat source thereinside, at least two press rollers disposed opposite to the heat roller, at least one cam member to move at least one of the press rollers close to the heat roller or away from the heat roller, a driving unit to rotate the cam member, and a control unit to control the driving unit to determine a position of the cam member. A sensor is mounted in an upstream side of the press rollers with respect to a feeding direction of a printing medium to detect a position of the printing medium. When a front end of the printing medium is sensed by the sensor, the control unit controls the driving unit to rotate the cam member. If the cam member rotates, the press rollers interlock with the cam member to move close to the heat roller or away from the heat roller.

### CROSS-REFERENCE TO RELATED APPLICATIONS

This application claims the benefit under 35 U.S.C. §119(a) from Korean Patent Application No. 2007-0040596, filed on Apr. 26, 2007 in the Korean Intellectual Property Office, the disclosure of which is incorporated herein by reference in its entirety.

### BACKGROUND OF THE INVENTION

1. Field of the Invention

The present general inventive concept relates to an image forming apparatus, and more particularly, to an image forming apparatus which is improved in a structure of a fusing device so as to prevent deterioration of an image quality.

2. Description of the Related Art

An image forming apparatus is an apparatus that prints an image on a printing medium, e.g., paper, according to an inputted image signal. As one type of the image forming apparatus, an electrophotographic image forming apparatus is configured such that light is scanned to a photosensitive medium charged with a predetermined electric potential to form an electrostatic latent image on an outer peripheral surface of the photosensitive medium, the electrostatic latent image is developed into a toner image by supplying a toner to the electrostatic latent image, and the toner image is transferred onto paper. The toner image transferred onto the paper is just carried on the paper, but is not fixed to the paper. Thus, the toner image necessarily passes through a fusing device provided in the image forming apparatus to be fused to the paper by heat and pressure.

A conventional fusing device includes a heat roller which has a heat source therein, and a press roller which is in close contact with the heat roller and forms a fusing nip at a contact portion with the heat roller. If the paper, onto which the toner image is transferred, passes between the rotating heat roller and press roller, the toner image is fused to the paper by the heat transferred from the interior of the heat roller and the pressure applied between the heat roller and the press roller.

The fusing performance of the fusing device is in proportion to a width of a fusing nip. Thus, in order to increase the performance of the fusing device which has only one press roller, the press roller should have a large diameter. However, if the diameter of the press roller increases, the diameter of the heat roller should increase correspondingly thereto, which results in a problem in that an overall size of the fusing device increases and a problem in that the image forming apparatus cannot be made compactly.

To cope with the above problem, it has been recently proposed to use two press rollers having a relatively small size, an example of which is illustrated in FIG. 1A. A fusing device illustrated in FIG. 1A includes a heat roller 2 which has a heat source 1 therein to generate heat, a first press roller 3 which is in close contact with the heat roller 2 to form a first fusing nip N1 at a contact portion with the heat roller 2, and a second press roller 4 which is in close contact with the heat roller 2 to form a second fusing nip N2 at a contact portion with the heat roller 2. Such a fusing device can be manufactured compactly, and further has the enhanced fusing performance because the overall width of the fusing nips is increased.

However, the conventional fusing device of FIG. 1A has a problem in that a front end of paper S having passed through the first fusing nip N1 cannot smoothly advance into the second fusing nip N2 and collides with the second press roller 4. If the front end of the paper S collides with the second press roller 4, the shock due to the collision is transmitted to the image transferred onto the paper, and causes deterioration of an image quality. Further, the collision with the second press roller 4 interrupts the smooth paper feed, and causes a paper jam.

In order to solve this problem, as illustrated in FIG. 1B, a paper guide 7 is mounted between a first press roller 5 and a second press roller 6. The paper guide 7 guides the paper S having passed through the first fusing nip N1 to advance smoothly into the second fusing nip N2. However, when the paper guide 7 is applied to an image forming apparatus capable of performing a duplex printing operation, the paper guide 7 may cause deterioration of an image quality. In other words, in the duplex printing operation, an image is printed on the surface of the paper, which contacts the paper guide 7. So, when the paper S is guided by the paper guide 7, if the paper S experiences heavy friction with the paper guide 7, the deterioration of an image quality such as image scratches may be caused.

### SUMMARY OF THE INVENTION

The present general inventive concept provides an image forming apparatus that includes plural press rollers improved so as to prevent deterioration of an image quality.

Additional aspects and/or advantages of the general inventive concept will be set forth in part in the description which follows and, in part, will be obvious from the description, or may be learned by practice of the general inventive concept.

The foregoing and/or other aspects and utilities of the present general inventive concept may be achieved by providing an image forming apparatus including a heat roller having a heat source thereinside, at least two press rollers disposed opposite to the heat roller, at least one cam member to move at least one of the press rollers close to the heat roller or away from the heat roller, a driving unit to rotate the cam member, and a control unit to control the driving unit to determine a position of the cam member.

The press rollers may include a first press roller which is in close contact with the heat roller, and a second press roller which is disposed in a downstream side of the first press roller and moves between a first position in which the second press roller closely contacts the heat roller and a second position in which the second press roller is spaced apart from the heat roller.

The image forming apparatus may further include a sensor mounted in an upstream side of the first press roller with respect to a feeding direction of a printing medium to detect a position of the printing medium.

The cam member may include a first cam member to move the second press roller. When a front end of the printing medium is sensed by the sensor, the control unit rotates the first cam member to move the second press roller to the second position.

When a predetermined time elapses, the control unit may rotate the first cam member to move the second press roller to the first position.

The first press roller may be mounted movably between a first press position of pressing the heat roller with a first pressure and a second press position of pressing the heat roller with a second pressure larger than the first pressure. The cam member may include a second cam member to move the first press roller. When a front end of the printing medium is sensed by the sensor, the control unit rotates the second cam member to move the first press roller to the second press position.

When a predetermined time elapses, the control unit may rotate the second cam member to move the first press roller to the first press position.

The driving unit may include at least one power transmission member to transmit a rotational force of the first cam member to the second cam member so that the second cam member interlockingly rotates with the first cam member.

The driving unit may include a driving source, and a power intermittence device to intermit power transmitted to the first cam member from the driving source.

The foregoing and/or other aspects and utilities of the present general inventive concept may also be achieved by providing an image forming apparatus including a heat roller having a heat source thereinside, plural press rollers disposed opposite to the heat roller, a printing medium guide disposed between the plural press rollers, and movable between a first position adjacent to the heat roller and a second position spaced apart from the heat roller farther than the first position, a cam member to move the printing medium guide, a driving unit to rotate the cam member, and a control unit to control the driving unit to determine a position of the cam member.

The image forming apparatus may further include a sensor mounted in an upstream side of the press rollers with respect to a feeding direction of a printing medium to detect a position of the printing medium.

When a front end of the printing medium is sensed by the sensor, the control unit may rotate the cam member to move the printing medium guide to the second position. When a predetermined time elapses, the control unit again rotates the cam member to move the printing medium guide to the first position.

The foregoing and/or other aspects and utilities of the present general inventive concept may be achieved by providing an image forming apparatus including a heat roller, a first press roller mounted movably between a first press position of pressing the heat roller with a first pressure and a second press position of pressing the heat roller with a second pressure larger than the first pressure, a second press roller disposed in a downstream side of the first press roller with respect to a feeding direction of a printing medium, and movable between a first position in which the second press roller closely contacts the heat roller and a second position in which the second press roller is spaced apart from the heat roller, a first cam member to move the second press roller, a second cam member to move the first press roller, and a driving unit to rotate the first cam member and the second cam member.

The driving unit may include at least one power transmission member to transmit a rotational force of the first cam member to the second cam member so that the second cam member interlockingly rotates with the first cam member.

The driving unit may include a driving source, and a power intermittence device to intermit power transmitted to the first cam member from the driving source. The power intermittence device includes a spring clutch having plural position determination parts to determine positions of the first cam member and the second cam member, and a restriction unit restricting the position determination parts in an ON/OFF state.

When the restriction unit restricts any one of the plural position determination parts, the first press roller may be located in the second press position, and the second press roller is located in the second position.

When the restriction unit restricts the other one of the plural position determination parts, the first press roller may be located in the first press position, and the second press roller is located in the first position.

The foregoing and/or other aspects and utilities of the present general inventive concept may be achieved by providing an image forming apparatus including a heat roller, a first press roller disposed to face the heat roller to form a printing medium path with the heat roller, and a second press roller disposed to the heat roller to form the printing medium path with the heat roller, and to move between a first position and a second position with respect to the heat roller.

The first press roller may move with respect to the heat roller between a first press position and a second press position.

The first press roller may contact the heat roller with a first pressure in the first press position, and with a second pressure in the second press position.

The first press roller may contact the heat roller in the first press position and the second press position.

The second press roller may be spaced-apart from the heat roller by a first distance in the first position and by a second distance in the second position.

The second press roller may contact the heat roller in the first position and is spaced-apart from the heat roller in the second position.

The first press roller may contact the heat roller with a variable pressure, and the second press roller may move toward and away from the heat roller in the first position and the second position.

### BRIEF DESCRIPTION OF THE DRAWINGS

These and/or other aspects and utilities of the present general inventive concept will become apparent and more readily appreciated from the following description of the embodiments, taken in conjunction with the accompanying drawings, of which:

FIGS. 1A and 1B are views schematically illustrating constitutions of conventional fusing devices;

FIG. 2 is a sectional view illustrating an image forming apparatus according to an embodiment of the present general inventive concept;

FIGS. 3 and 5 are side views illustrating a fusing device and cam members of the image forming apparatus of FIG. 2;

FIGS. 4 and 6 are views illustrating a driving unit to rotate the cam members of FIGS. 3 and 5;

FIG. 7 is a perspective view illustrating a spring clutch of a power intermittence device of the driving unit of FIGS. 4 and 6;

FIG. 8 is a view illustrating a position relation between a locking member of a restriction unit and position determination parts of a spring clutch in the driving unit of FIGS. 4, 6 and 7; and

FIGS. 9 and 10 are side views illustrating a partial constitution of a fusing device and cam members in an image forming apparatus according to a embodiment of the present general inventive concept.

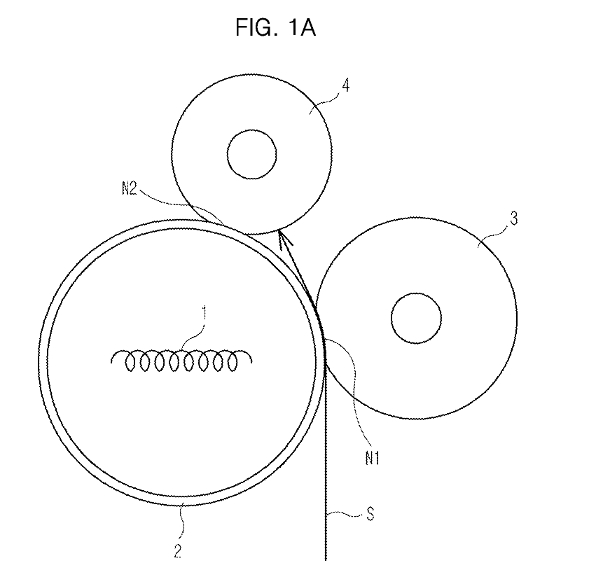

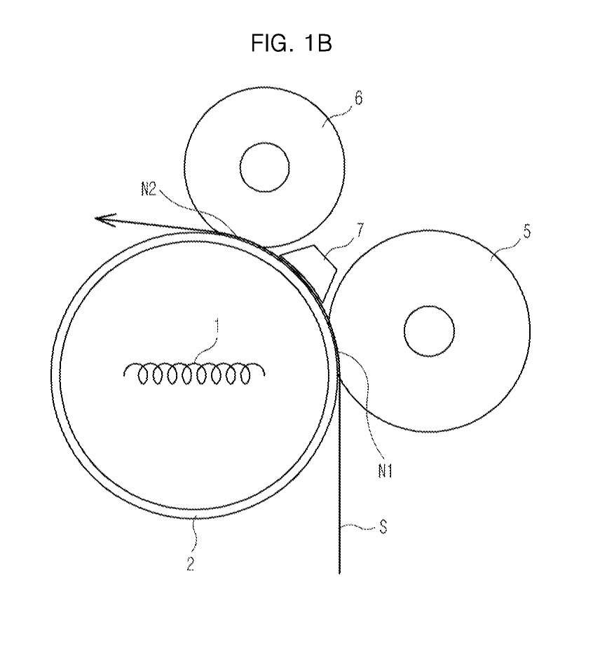

### DETAILED DESCRIPTION OF THE PREFERRED EMBODIMENTS

Reference will now be made in detail to embodiments of the present general inventive concept, examples of which are illustrated in the accompanying drawings, wherein like reference numerals refer to like elements throughout. The embodiments are described below in order to explain the present general inventive concept by referring to the figures.

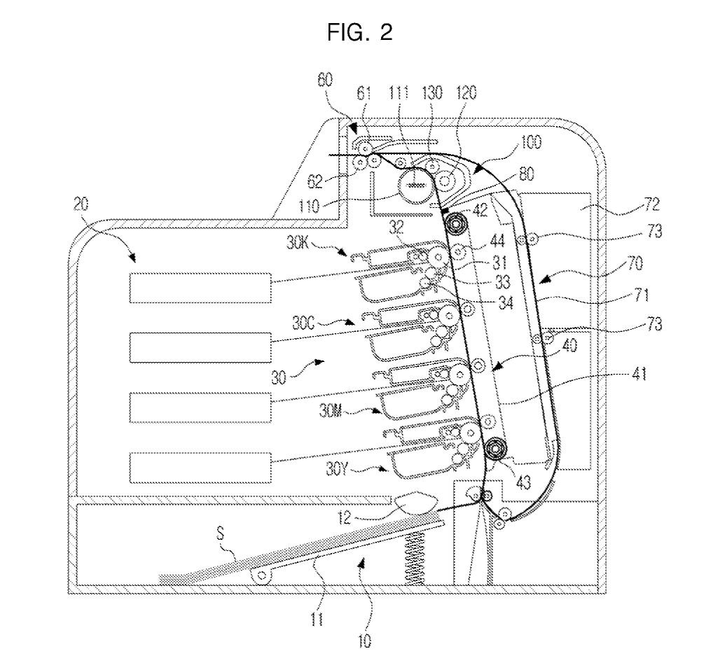

FIG. 2 is a sectional view illustrating an image forming apparatus in accordance with an embodiment of the present general inventive concept.

As illustrated in FIG. 2, the image forming apparatus according to the present embodiment includes a paper supply device 10, an exposure device 20, a developing device 30, a transfer device 40, a fusing device 100, a paper discharge device 60, and a duplex printing device 70.

The paper supply device 10 supplies a printing medium, i.e., paper S, and includes a paper tray 11 on which paper sheets are stacked, and a pickup roller 12 which picks up a sheet of paper loaded on the paper tray 11. The paper picked up by the pickup roller 12 is fed toward the developing device 30.

The developing device 30 includes four developing cartridges 30Y, 30M, 30C and 30K in which toners of different colors, e.g., yellow (Y), magenta (M), cyan (C) and black (K) toners, are respectively stored. The developing cartridges 30Y, 30M, 30C and 30K are respectively provided with photosensitive bodies 31 on which electrostatic latent images are formed by the exposure device 20. The exposure device 20 irradiates light, corresponding to image information of yellow, magenta, cyan and black, to the photosensitive bodies 31 of the developing cartridges according to a printing signal.

Each of the developing cartridges 30Y, 30M, 30C and 30K includes a charge roller 32 which charges each photosensitive body 31, a developing roller 33 which develops the electrostatic latent image formed on each photosensitive body 31 into a toner image, and a supply roller 34 which supplies the toner onto the developing roller 33.

The transfer device 40 transfers the toner images developed on the photosensitive bodies onto the paper, and includes a transfer belt 41 which circulates while contacting the photosensitive bodies 31, a driving roller 42 which drives the transfer belt 41, a tension roller 43 which keeps the tension of the transfer belt 41 constant, and four transfer rollers 44 which transfer the toner images developed on the photosensitive bodies 31 onto the paper.

The fusing device 100 fuses the image to the paper by applying heat and pressure to the paper, and includes a heat roller 110 which has a heat source 111 therein to heat the toner-transferred paper, and plural press rollers 120 and 130 which are disposed opposite to the heat roller 110 with respect to a paper path of the paper S and maintain a constant fusing pressure with the heat roller 110 on the paper S. Although this embodiment exemplifies that two press rollers are provided, the number of press rollers can be changed adequately as needed. The detailed description of the fusing device 100 will be made later.

The paper discharge device 60 discharges the printed paper to an outside of the image forming apparatus, and includes a discharge roller 61 which receives power to rotate, and a discharge backup roller 62 which is mounted opposite to the discharge roller 61.

The duplex printing device 70 is provided to feed the paper, of which one surface has been printed, to the upstream of the developing device 30, so as to print the image on both surfaces of the paper. The duplex printing device 70 includes a guide frame 72 which forms a duplex print path 71, and a duplex print roller 73 which is mounted in the duplex print path 71 to feed the paper.

The image forming apparatus of the present invention further includes a sensor 80 which is mounted in the upstream side of the fusing device 100 with respect to a paper feeding direction to detect the position of the paper S. If the sensor 80 senses a front end of the paper S, it can be expected that the paper advances into the fusing device 100 soon.

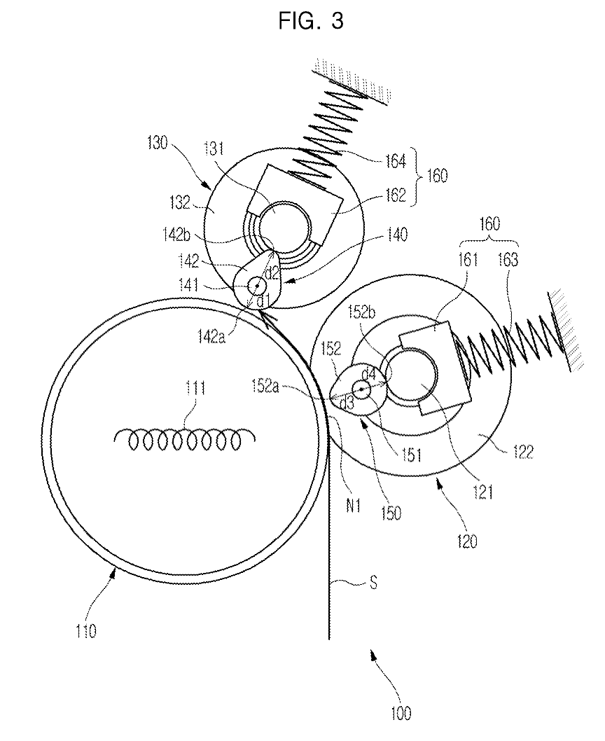

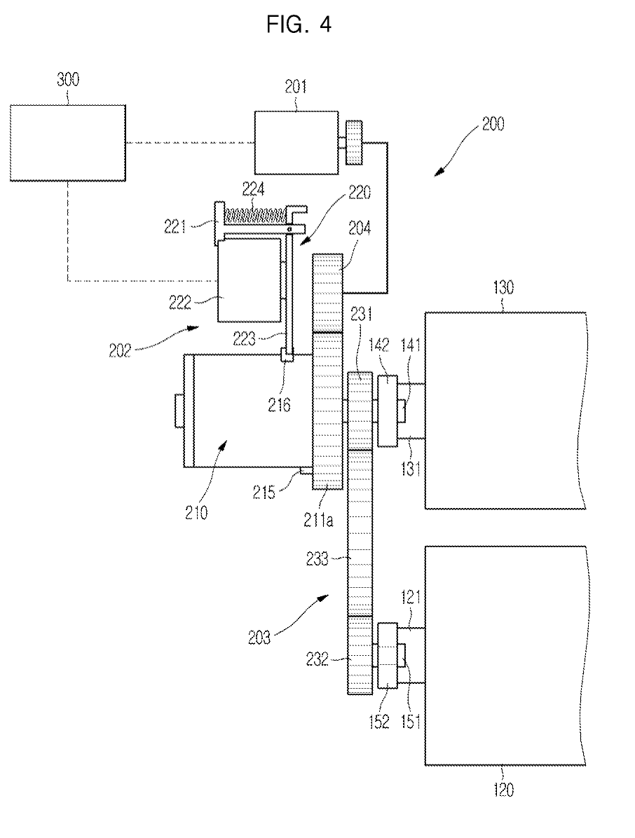

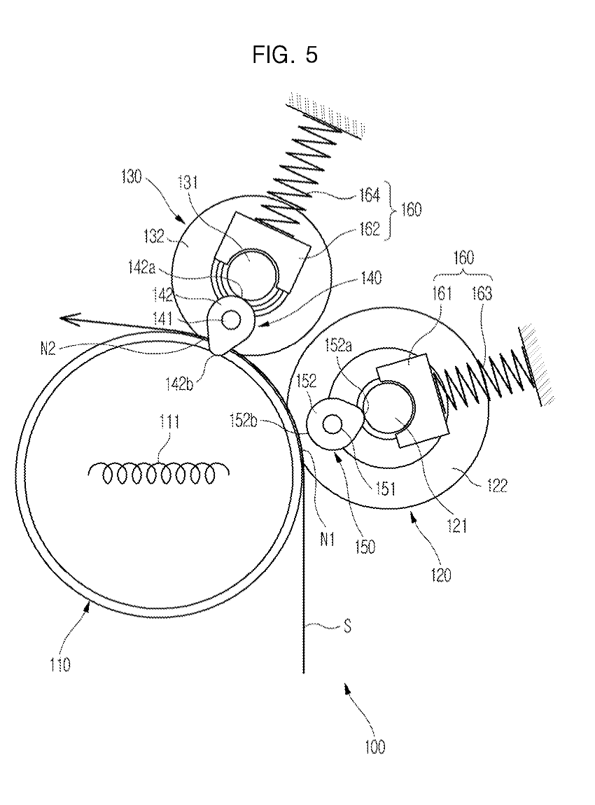

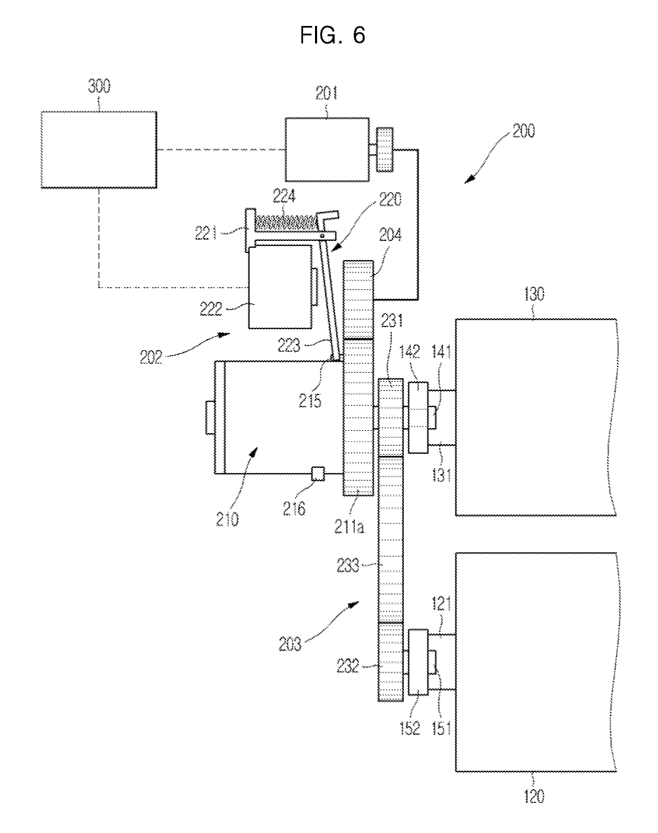

FIGS. 3 and 5 are side views illustrating the fusing device 100 and cam members 140 and 150 of the image forming apparatus of FIG. 2, and FIGS. 4 and 6 are views illustrating a driving unit 200 to rotate the cam members 140 and 150 according to the present general inventive concept. FIGS. 3 and 4 illustrate a state in which a first press roller 120 and a second press roller 130 are located in a second press position and a second position, respectively, and FIGS. 5 and 6 show a state in which the first press roller 120 and the second press roller 130 are located in a first press position and a first position, respectively.

As illustrated in FIGS. 3 to 6, the fusing device 100 includes the heat roller 110 which has the heat source 111 therein, the first press roller 120 which is in close contact with the heat roller 110 and forms a first fusing nip N1 with the heat roller 110, the second press roller 130 which is disposed in the downstream side of the first press roller 120 with respect to the paper feed direction, and press devices 160 which bias the first press roller 120 and the second press roller 130 to closely contact the heat roller 110. The press devices 160 include supporting members 161 and 162 which rotatably support shafts 121 and 131 of the respective press rollers 120 and 130, and elastic members 163 and 164 which elastically bias the supporting members 161 and 162 with respect to a reference so that the press rollers 120 and 130 can closely contact the heat roller 110.

The heat source 111 of the heat roller 110 may be configured as a halogen lamp, a heating coil, an induction heater, or the like. The first press roller 120 and the second press roller 130 respectively include shafts 121 and 131 which are made of a metal material, such as aluminum or steel, and elastic layers 122 and 132 which surround the shafts 121 and 131 and form the fusing nips N1 and N2 by being elastically deformed when the first press roller 120 and the second press roller 130 are pressed toward the heat roller 110. The elastic layers 122 and 132 are typically made of silicon rubber, and are provided with release layers (not illustrated) on their surfaces, to prevent the paper S from sticking to the press rollers 120 and 130.

The second press roller 130 can move between a first position in which the second press roller 130 closely contacts the heat roller 110 (refer to FIG. 5) and a second position in which the second press roller 130 is spaced apart from the heat roller 110 (refer to FIG. 3). When the second press roller 130 is in the first position, the second press roller 130 forms the second fusing nip N2 with the heat roller 110. When the second press roller 130 is separated from the heat roller 110, the front end of the paper S having passed through the first fusing nip N1 smoothly advances between the heat roller 110 and the second press roller 130. After the front end of the paper S advances between heat roller 110 and the second press roller 130, the second press roller 130 moves to the first position to press the paper.

Also, the first press roller 120 can move between a first press position in which the first press roller 120 is pressed toward the heat roller 110 by a first pressure P1 (refer to FIG. 5) and a second press position in which the first press roller 120 is pressed to the heat roller 110 by a second pressure P2 which is greater than the first pressure (refer to FIG. 3). When the front end of the paper S advances between the heat roller 110 and the first press roller 120, the first press roller 120 is located in the second press position to strongly press the paper S, thereby causing the front end of the paper to be curled toward the heat roller 110. Accordingly, the paper S can advance smoothly between the heat roller 110 and the second press roller 130.

The image forming apparatus of the present general inventive concept further includes at least one cam members 140 and 150 to move the first press roller 120 and the second press roller 130 with respect to the heat roller 110 or a reference position, a driving unit 200 to drive the cam members 140 and 150, and a control unit 300 which controls the driving unit 200 to determine the positions of the cam members 140 and 150. This embodiment exemplifies that two cam members 140 and 150 are provided respectively correspondingly to the first press roller 120 and the second press roller 130. Hereinafter, the cam member 140 to move the second press roller 130 will be referred to as a second cam member, and the cam member 150 to move the first press roller 120 will be referred to as a first cam member.

As illustrated in FIGS. 3 and 5, the second cam member 140 includes a cam shaft 141, and a rotating cam 142 which is provided at an end portion of the cam shaft 141. The rotating cam 142 has a first portion 142a which extends from a rotational center by a distance d1 in a radial direction, and a second portion 142b which extends by a distance d2 (d2>d1). When the first portion 142a of the rotating cam 142 contacts the shaft 131 of the second press roller 130, the second press roller 130 is located in the first position, and accordingly the second press roller 130 closely contacts the heat roller 110 (refer to FIG. 5). On the other hand, when the second portion 142b of the rotating cam 142 presses the shaft 131 of the second press roller 130, the second press roller 130 is located in the second position, and accordingly the second press roller 130 is separated from the heat roller 110 (refer to FIG. 3).

Similarly, the first cam member 150 includes a cam shaft 151 and a rotating cam 152. The rotating cam 152 of the first cam member 150 has a first portion 152a which extends from a rotational center by a distance d3 in a radial direction, and a second portion 152b which extends by a distance d4 (d4<d3). When the first portion 152a of the rotating cam 152 presses the shaft 121 of the first press roller 120, the first press roller 120 presses the heat roller 110 by the pressure P1 in the first press position (refer to FIG. 5). On the other hand, when the second portion 152b of the rotating cam 152 contacts the shaft 121 of the first press roller 120, the first press roller 120 presses the heat roller 110 by the pressure P2 (P2>P1) in the second press position (refer to FIG. 3).

As illustrated in FIGS. 4 and 6, the driving unit 200 to drive the cam members 140 and 150 includes a driving motor 201 of a driving source, a power intermittence device 202 which intermits the power transmitted from the driving motor 201 to the second cam member 140, and a power transmission device 203 which connects the second cam member 140 and the first cam member 150 so that the first cam member 150 can interlockingly rotate with the second cam member 140.

The power intermittence device 202 includes a spring clutch 210 which is connected coaxially with the second cam member 140, and a restriction unit 220 which restricts the spring clutch 210. The power from the driving motor 201 is transmitted through a gear train, and rotates a clutch gear 211a of the spring clutch 210. FIGS. 4 and 6 illustrate only a gear 204, which is engaged with the clutch gear 211a, of the gear train connecting the driving motor 201 and the clutch gear 211a.

The power transmission device 203 includes a first power transmission gear 231 which is coaxially mounted to the cam shaft 141 of the second cam member 140, a second power transmission gear 232 which is coaxially mounted to the cam shaft 151 of the first cam member 150, and a connecting gear 233 which connects the first power transmission gear 231 and the second power transmission gear 232.

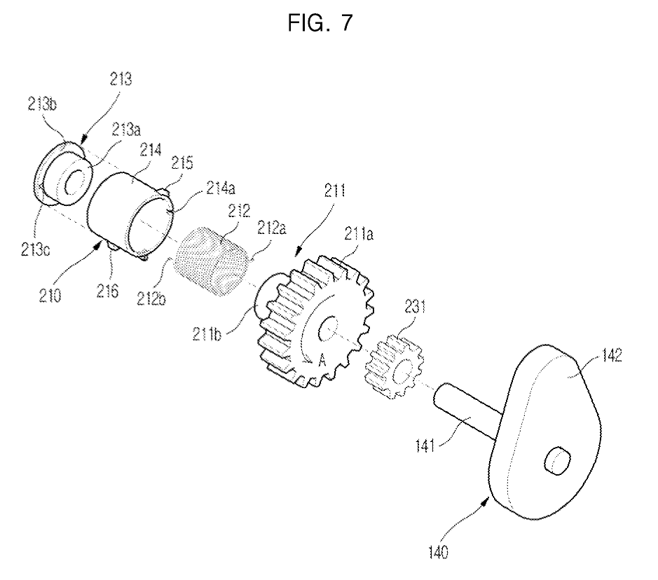

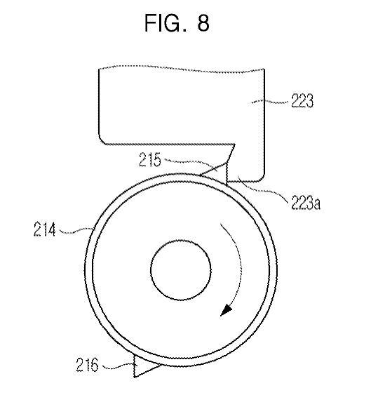

FIG. 7 is a perspective view illustrating the spring clutch of the power intermittence device 202 of FIGS. 4 and 6 according to an embodiment of the present general inventive concept, and FIG. 8 is a view illustrating a locking member of the restriction unit 220 and position determination parts 215 and 216 of the spring clutch 210 of FIGS. 4 and 6 according to an embodiment of the present general inventive concept.

As illustrated in FIG. 7, the spring clutch 210 includes a first hub 211 which is integrally formed with the clutch gear 211a, a second hub 213 which is intermittently connected to the first hub 211 by a clutch spring 212, and a cylindrical clutch hub 214 which houses the clutch spring 212 between the first hub 211 and the second hub 213. A front end of the cam shaft 141 is coupled to the second hub 213. Therefore, if the second hub 213 rotates, the cam shaft 141 of the second cam member 140 rotates, and the power is transmitted to the rotating cam 142.

One portion of the clutch spring 212 is fitted on a cylinder portion 211b of the first hub 211, and the other portion of the clutch spring 212 is fitted on a cylinder portion 213a of the second hub 213. One end portion 212a of the clutch spring 212 is fixed in a spring fixing slit 214a formed on the clutch hub 214, and the other end portion 212b of the clutch spring 212 is fixed in a spring fixing hole 213c formed on a flange portion 213b of the second hub 213.

As illustrated in FIGS. 4, 6 and 8, the clutch hub 214 is provided with a pair of position determination parts 215 and 216 on its outer peripheral surface, to determine the stop positions of the first cam member 140 and the second cam member 150.

When the restriction unit 220 is in an OFF state, the first position determination part 215 interferes with a locking member 223. When the restriction unit 220 is in an ON state, the first position determination part 215 does not interfere with the locking member 223. If the first position determination part 215 is restricted by the restriction unit 220 by interfering with the locking member 223, that is, the restriction unit 220 is in the OFF state, the first portion 142a of the second cam member 140 contacts the second press roller 130, and the first portion 152a of the first cam member 150 contacts the first press roller 120. Thus, the second press roller 130 and the first press roller 120 are maintained in the first position and the first press position (refer to FIGS. 5 and 6).

When the restriction unit 220 is in the ON state, the second position determination part 216 interferes with the locking member 223. When the restriction unit 220 is in the OFF state, the second position determination part 216 does not interfere with the locking member 223. If the second position determination part 216 is restricted by the restriction unit 220 by interfering with the locking member 223, that is, the restriction unit 220 is in the ON state, the second portion 142b of the second cam member 140 contacts the second press roller 130, and the second portion 152b of the first cam member 150 contacts the first press roller 120. Thus, the second press roller 130 and the first press roller 120 are maintained in the second position and the second press position (refer to FIGS. 3 and 4).

As illustrated in FIG. 7, if the clutch gear 211 a rotates in a direction A by receiving the rotational force of the driving motor 201, the first hub 211 rotates in the A direction together with the clutch gear 211a. If the first hub 211 rotates while the position determination parts 215 and 216 are not restricted by the restriction unit 220, the clutch spring 212, which is in friction with the first hub 211, is twisted in an inner-diameter-increasing direction, and holds tightly the cylinder portions 211b and 213a of the first hub 211 and the second hub 213. The rotational force of the first hub 211 is transmitted through the clutch spring 212, so that the second hub 213 rotates together with the first hub 211 and the rotational force is transmitted to the first cam member 140. If the second cam member 140 rotates, the rotational force of the second cam member 140 is transmitted through the first power transmission gear 231, the connecting gear 233 and the second power transmission gear 232, so that the first cam member 150 also rotates.

However, if the restriction unit 220 interferes with the position determination parts 215 and 216 and restricts the movement of the clutch hub 214, although the first hub 211 rotates in the A direction, the clutch spring 212 cannot hold tightly the first hub 211 and the second hub 213. So, only the first hub 211 rotates idle, and the power is not transmitted to the second hub 213. Accordingly, the second cam member 140 and the first cam member 150 are in positions corresponding to the position determination parts 215 and 216 which are restricted by the restriction unit 220.

As illustrated in FIGS. 4 and 6, the restriction unit 220 includes a bracket 221, a solenoid 222 which is supported by the bracket 221, and the locking member 223 which moves reciprocatingly between a position in which the locking member 223 interferes with the first position determination part 215 (first locking position, refer to FIG. 6) and a position in which the locking member 223 interferes with the second position determination part 216 (second locking position, refer to FIG. 4). The locking member 223 is hingedly coupled to the bracket 221, and is provided with a latching protrusion 223a (refer to FIG. 8) which extends from one end of the locking member 223 toward the clutch hub 214. The locking member 223 is connected with a spring 224 at the other end, which elastically biases the other end of the locking member 223 so that the latching protrusion 223a of the locking member 223 moves to the first locking position.

This embodiment exemplifies that the first cam member 150 and the second cam member 140 are driven by one motor, however it may be modified such that the first cam member 150 and the second cam member 140 are respectively driven by separate motors. In such a modification, it is unnecessary to mount the power transmission device for connecting the second cam member 140 and the first cam member 150. Also, this embodiment exemplifies that the power intermittence device intermits the power transmitted to the first cam member, however it may be modified such that the power intermittence device can intermit the power transmitted to the second cam member.

Hereinafter, an operation of the image forming apparatus according to the embodiment will be described with reference to FIGS. 3 to 8.

If a printing command is inputted, the exposure device 20 irradiates light corresponding to image information of yellow, magenta, cyan and black to the photosensitive bodies 31 of the respective developing cartridges, to form electrostatic latent images on the surfaces of the photosensitive bodies 31. The toners in the respective developing cartridges 30Y, 30M, 30C and 30K are supplied to the developing rollers 33 by the supply rollers 34, and the toners on the developing rollers 33 are adhered to the electrostatic latent images formed on the photosensitive bodies 31 to form toner images of yellow, magenta, cyan and black on the respective photosensitive bodies 31.

The paper picked up by the pickup roller 12 is attached to the transfer belt 41, and is fed at the same speed as the running speed of the transfer belt 41. If voltage of an opposite polarity to the toners on the photosensitive bodies 31 is applied to the respective transfer rollers 44, the toner images on the photosensitive bodies 31 are transferred onto the paper S. While the paper S is fed, the toner images of yellow, magenta, cyan and black formed on the respective photosensitive bodies 31 are overlappingly transferred onto the paper S in sequence, and as a result a completed color toner image is formed on the paper S.

The toner image-transferred paper passes by the sensor 80 which is mounted between the transfer device 40 and the fusing device 100. If the sensor 80 senses the front end of the paper S, the control unit 300 controls the driving unit 200 to move the first press roller 120 and the second press roller 130 to the second press position and the second position, respectively, as illustrated in FIG. 3.

The control unit 300 rotates the driving motor 201, and applies electric current to the solenoid 222 of the restriction unit 220. The locking member 223 is pulled toward the solenoid 222, and moves to a second locking position, i.e., a position in which the locking member 223 interferes with the second position determination part 216. Therefore, the second cam member 140 rotates until the second position determination part 216 is caught by the latching protrusion 223a of the locking member 223, and the power is transmitted through the power transmission device 203, so that the first cam member 150 also rotates. If the second position determination part 216 is caught by the latching protrusion 223a, the second cam member 140 and the first cam member 150 stop. At this time, the second portion 142b of the second cam member 140 contacts the shaft 131 of the second press roller 130 to move the second press roller 130 to the second position, and the second portion 152b of the first cam member 150 contacts the shaft 121 of the first press roller 120 to move the first press roller 120 to the second press position.

While the first press roller 120 and the second press roller 130 are respectively located in the second press position and the second position, the toner image-transferred paper S advances to the first fusing nip N1 formed between the first press roller 120 and the heat roller 110, and the image is fused to the paper S by heat and pressure. At this time, the front end of the paper S is curled toward the heat roller 110 by the pressure P2 applied between the first press roller 120 and the heat roller 110. Because the second press roller 130 is spaced apart from the heat roller 110 at a predetermined distance, the paper S having passed by the first fusing nip N1 can advance smoothly to the second fusing nip N2.

If a predetermined time elapses after the sensor 80 senses the front end of the paper S (time taken for the front end of the paper S to advance to the second fusing nip N2, which can be estimated from the paper feeding speed), the control unit 300 turns the solenoid 222 OFF. The locking member 223 moves to a first locking position, i.e., the position in which the locking member 223 interferes with the first position determination part 215, by the elastic force of the spring 224. The second cam member 140 rotates until the first position determination part 215 is caught by the latching protrusion 223a of the locking member 223. The power is transmitted through the power transmission device 203, so that the first cam member 150 also rotates. If the first position determination part 215 is caught by the latching protrusion 223a, the second cam member 140 and the first cam member 150 stop. At this time, as illustrated in FIG. 5, the first portion 142a of the second cam member 140 contacts the shaft 131 of the second press roller 130 to move the second press roller 130 to the first position, and the first portion 152a of the first cam member 150 contacts the shaft 121 of the first press roller 120 to move the first press roller 120 to the first press position. Therefore, the second press roller 130 closely contacts the heat roller 110 to form the second fusing nip N2, and presses the paper S to fuse the toner image to the paper. The first press roller 120 presses the paper S at the pressure P1, which is lower than the pressure P2. This is for preventing the paper from being wrinkled or damaged due to the high pressure.

The paper S, which has undergone the above fusing process, is discharged to the outside by the paper discharge device 60, or is fed reversely to move again toward the developing device 30 for duplex printing.

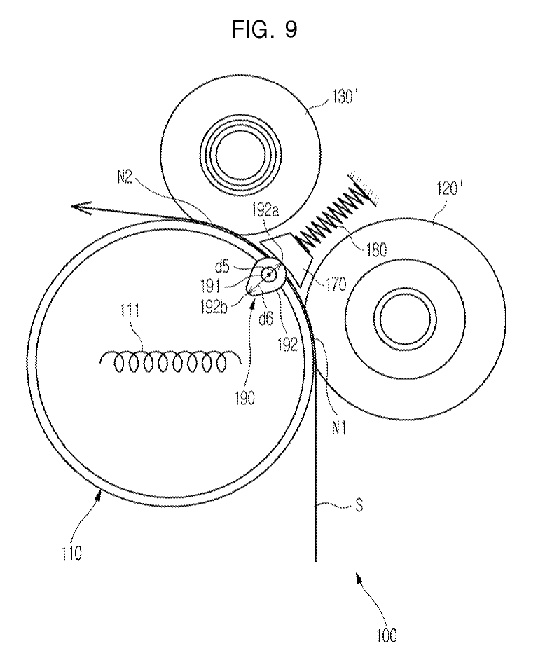

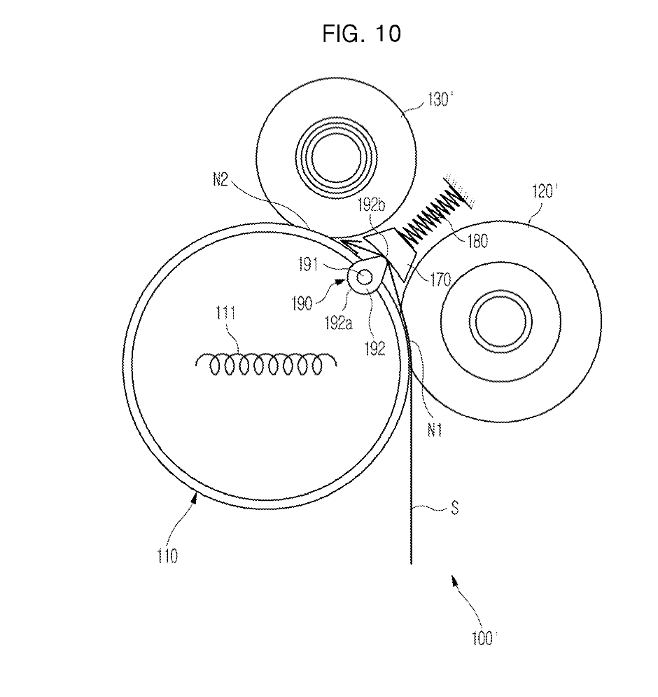

FIGS. 9 and 10 are side views illustrating a partial constitution of a fusing device and cam members in an image forming apparatus according to an embodiment of the present general inventive concept. FIG. 9 illustrates a state in which a printing medium guide is located in a first position, and FIG. 10 illustrates a state in which the printing medium guide is located in a second position. Hereinafter, the distinguished features of this embodiment will be primarily described with reference to FIGS. 9 and 10, and other features similar to those of FIGS. 3 to 8 will be briefly described.

As illustrated in FIGS. 9 and 10, a fusing device 100′ of this embodiment includes a heat roller 110 which has a heat source 111 therein, a first press roller 120′ which is in close contact with the heat roller 110 and forms a first fusing nip N1, a second press roller 130′ which is disposed in the downstream of the first press roller 120′ with respect to the paper feed direction and is in close contact with the heat roller 110 and forms a second fusing nip N2, a printing medium guide 170 which is mounted between the first press roller 120′ and the second press roller 130′ and guides the paper having passed by the first fusing nip N1 to smoothly advance to the second fusing nip N2, and an elastic member 180 which elastically biases the printing medium guide 170 toward the heat roller 110.

The printing medium guide 170 can move between a first position in which the printing medium guide 170 is located adjacent to the heat roller 110 (refer to FIG. 9) and a second position in which the printing medium guide 170 is spaced away from the heat roller 110 farther than the first position (refer to FIG. 10). The printing medium guide 170 is spaced apart from the heat roller by a first distance, in the first position, and by a second distance in the second position.

The image forming apparatus of this embodiment further includes a cam member 190 to move the printing medium guide 170, a driving unit 200 (refer to FIGS. 4 and 6) to rotate the cam member 190, and a control unit 300 (refer to FIGS. 4 and 6) which controls the driving unit 200 to determine the position of the cam member 190.

Similarly to FIGS. 3 and 5, the cam member 190 includes a cam shaft 191, and a rotating cam 192 which is provided at an end portion of the cam shaft 191. The rotating cam 192 has a first portion 192a which extends from a rotational center by a distance d5 in a radial direction, and a second portion 192b which extends by a distance d6 (d6>d5). When the first portion 192a contacts the printing medium guide 170, the printing medium guide 170 is located in the first position. When the second portion 192b contacts the printing medium guide 170, the printing medium guide 170 is located in the second position.

As illustrated in FIGS. 4 and 6, the driving unit for driving the cam member 190 includes a driving motor 201 as a driving source, and a spring clutch 210 and a restriction unit 220 which intermit the power transmitted from the driving motor 201 to the cam member 190. Since this embodiment is constituted such that the driving unit 200 drives only one cam member 190, the power transmission device 203 in the previous embodiment is not needed.

Because the operation of the driving unit to rotate the cam member 190 and the operation of the control unit to control the position of the cam member 190 can be easily analogized from FIGS. 3 to 8, the explanation thereof will be omitted.

Referring to FIG. 2, in the duplex printing operation, the paper S, of which one surface has been printed, is reversed by the discharge roller 61, and is fed to the upstream side of the developing device 30 by the duplex printing device 70. By undergoing again the developing, transfer and fusing processes, the image is printed on the other surface of the paper.

In the duplex printing operation, if the front end of the paper S is sensed by the sensor 80 (refer to FIG. 2), the control unit 300 controls the driving motor 201 and the solenoid 222 (refer to FIGS. 4 and 6) of the restriction unit to rotate the cam member 190, as illustrated in FIG. 10, so that the second portion 192b of the cam member 190 comes into contact with the printing medium guide 170. The printing medium guide 170 moves to the second position which is at a relatively long distance from the heat roller 110, thereby minimizing a degree of friction with the paper S passing by the first fusing nip N1.

If a predetermined time elapses after the sensor 80 senses the front end of the paper S (time taken for the front end of the paper S to advance to the second fusing nip N2, which can be estimated from the paper feeding speed), the control unit 300 controls the solenoid 222 to rotate the cam member 190, as shown in FIG. 9, so that the first portion 192a of the cam member 190 comes into contact with the printing medium guide 170. The printing medium guide 170 moves to the first position adjacent to the heat roller 110 by the elastic force of the elastic member 180. Once the front end of the paper S advances to the second fusing nip N2, the paper S closely contacts the heat roller 110 by the feeding force applied between the heat roller 110 and the second press roller 130′. Accordingly, though the printing medium guide 170 is located at the first position adjacent to the heat roller 110, the friction between the paper S and the printing medium guide 170 does not cause a problem, such as a paper jam.

As apparent from the above description, the image forming apparatus according to the present general inventive concept enables the printing medium having passed by the first press roller to advance smoothly between the heat roller and the second press roller. Accordingly, the present invention can prevent a jam caused between the first press roller and the second press roller or deterioration of an image quality due to the collision of the printing medium with the second press roller.

Further, also when the printing medium guide is provided between the plural press rollers, the present general inventive concept can minimize image scratches caused by the printing medium guide in the duplex printing operation.

Although embodiments of the present general inventive concept have been shown and described, it would be appreciated by those skilled in the art that changes may be made in these embodiments without departing from the principles and spirit of the general inventive concept, the scope of which is defined in the appended claims and their equivalents.

What is claimed is:

1. An image forming apparatus comprising:
a heat roller having a heat source;
at least two press rollers disposed to contact the heat roller;
at least one cam member; and
a driving unit to rotate the cam member to move at least one of the press rollers close to the heat roller or away from the heat roller.

2. The image forming apparatus of claim 1, wherein the press rollers include a first press roller which is in close contact with the heat roller, and a second press roller which is disposed in a downstream side of the first press roller and moves between a first position in which the second press roller closely contacts the heat roller and a second position in which the second press roller is spaced apart from the heat roller.

3. The image forming apparatus of claim 2, further comprising:
a sensor mounted in an upstream side of the first press roller with respect to a feeding direction of a printing medium to detect a position of the printing medium.

4. The image forming apparatus of claim 3, further comprising:
a control unit to control the driving unit to determine a position of the cam member, wherein:
the cam member includes a first cam member to move the second press roller; and
when a front end of the printing medium is sensed by the sensor, the control unit rotates the first cam member to move the second press roller to the second position.

5. The image forming apparatus of claim 4, wherein when a predetermined time elapses, the control unit again rotates the first cam member to move the second press roller to the first position.

6. The image forming apparatus of claim 3, further comprising:
a control unit to control the driving unit to determine a position of the cam member,
wherein:
the first press roller is mounted movably between a first press position of pressing the heat roller with a first pressure and a second press position of pressing the heat roller with a second pressure larger than the first pressure;
the cam member includes a second cam member to move the first press roller; and
when a front end of the printing medium is sensed by the sensor, the control unit rotates the second cam member to move the first press roller to the second press position.

7. The image forming apparatus of claim 6, wherein when a predetermined time elapses, the control unit again rotates the second cam member to move the first press roller to the first press position.

8. The image forming apparatus of claim 6, wherein the driving unit includes at least one power transmission member to transmit a rotational force of the first cam member to the second cam member so that the second cam member interlockingly rotates with the first cam member.

9. The image forming apparatus of claim 3, wherein the driving unit includes a driving source, and a power intermittence device to intermit power transmitted to the first cam member from the driving source.

10. An image forming apparatus comprising:
a heat roller having a heat source thereinside;
plural press rollers disposed opposite to the heat roller;
a printing medium guide disposed between the plural press rollers, movably between a first position adjacent to the heat roller and a second position spaced apart from the heat roller farther than the first position;
a cam member to move the printing medium guide;
a driving unit to rotate the cam member; and
a control unit to control the driving unit to determine a position of the cam member.

11. The image forming apparatus according to claim 10, further comprising:
a sensor mounted in an upstream side of the press rollers with respect to a feeding direction of a printing medium to detect a position of the printing medium.

12. The image forming apparatus according to claim 11, wherein when a front end of the printing medium is sensed by the sensor, the control unit rotates the cam member to move the printing medium guide to the second position, and
when a predetermined time elapses, the control unit again rotates the cam member to move the printing medium guide to the first position.

13. The image forming apparatus of claim 1, where:
the at least two press rollers comprise:
a first press roller mounted movably between a first press position of pressing the heat roller with a first pressure and a second press position of pressing the heat roller with a second pressure larger than the first pressure and
a second press roller disposed in a downstream side of the first press roller with respect to a feeding direction of a printing medium, movably between a first position in which the second press roller closely contacts the heat roller and a second position in which the second press roller is spaced apart from the heat roller; and
the at least one cam member comprises:
a first cam member to move the second press roller, and
a second cam member to move the first press roller; and
the driving unit rotates the first cam member and the second cam member.

14. The image forming apparatus of claim 13, further comprising:
a sensor mounted in an upstream side of the first press roller with respect to the feeding direction of the printing medium to detect a position of the printing medium.

15. The image forming apparatus of claim 13, wherein the driving unit includes at least one power transmission member to transmit a rotational force of the first cam member to the second cam member so that the second cam member interlockingly rotates with the first cam member.

16. The image forming apparatus of claim 13, wherein the driving unit includes a driving source, and a power intermittence device to intermit power transmitted to the first cam member from the driving source, and
the power intermittence device includes a spring clutch having plural position determination parts to determine positions of the first cam member and the second cam member, and a restriction unit restricting the position determination parts in an ON/OFF state.

17. The image forming apparatus of claim 16, wherein when the restriction unit restricts any one of the plural position determination parts, the first press roller is located in the second press position, and the second press roller is located in the second position.

18. The image forming apparatus of claim 17, wherein when the restriction unit restricts the other one of the plural position determination parts, the first press roller is located in the first press position, and the second press roller is located in the first position.

19. An image forming apparatus comprising:
a heat roller;
a first press roller disposed to face the heat roller to form a printing medium path with the heat roller; and
a second press roller disposed to the heat roller to form the printing medium path with the heat roller, and to move between a first position and a second position with respect to the heat roller.

20. The image forming apparatus of claim 19, wherein the first press roller moves with respect to the heat roller between a first press position and a second press position.

21. The image forming apparatus of claim 20, wherein the first press roller contacts the heat roller with a first pressure in the first press position, and with a second pressure in the second press position.

22. The image forming apparatus of claim 19, wherein the second press roller contacts the heat roller in the first position and is spaced-apart from the heat roller in the second position.

23. The image forming apparatus of claim 19, wherein:
the first press roller contacts the heat roller with a variable pressure; and
the second press roller moves toward and away from the heat roller in the first position and the second position.
